(19) United States
(12) Patent Application Publication
(10) Pub. No.: US 2026/0021431 A1
(43) Pub. Date: Jan. 22, 2026

(54) FILTER AND METHOD OF MAKING AND USING THE SAME

(71) Applicant: SAINT-GOBAIN PERFORMANCE PLASTICS CORPORATION, Malvern, PA (US)

(72) Inventors: Tao He, Shanghai (CN); Liqing Hong, Hangzhou (CN); Yong Zhang, Hangzhou (CN); Qi Zhu, Shanghai (CN); Penghui Wang, Shanghai (CN); Haiyan Hong, Shanghai (CN)

(21) Appl. No.: 19/273,363

(22) Filed: Jul. 18, 2025

(30) Foreign Application Priority Data
Jul. 19, 2024 (CN) 202410976850.9

(51) Int. Cl. B01D 35/30; B01D 29/05

(52) U.S. Cl. CPC B01D 35/30; B01D 29/05

(57) ABSTRACT

The present application is directed to a filter including: a first housing member having a fluid inlet port; a second housing member positioned axially underneath the first housing member, the second housing member having a fluid outlet port; a porous filter element disposed between the first and second housing members; and a thermoplastic overmold which is molded over the periphery of the housing members sealing the periphery of the housing members together to form an internal volume housing the porous filter element, where the first housing member includes a radial sidewall comprising at least one axial step, and where the second housing member includes a substantially rectilinear radial sidewall

### CROSS-REFERENCE TO RELATED APPLICATION(S)

This application claims priority to and the benefit of Chinese Patent Application No. 202410976850.9, entitled “FILTER AND METHOD OF MAKING AND USING THE SAME,” by Tao HE et al., filed Jul. 19, 2024, which is assigned to the current assignee hereof and incorporated herein by reference in its entirety.

### FIELD OF THE DISCLOSURE

The present disclosure relates to a filter, and more particularly to, a filter for use in a sterilized environment.

### RELATED ART

Disposable disc filters are commonly products of industrial mass manufacturing and may be used in chemical, physical and pharmaceutical laboratories for the pressure filtration of fluid. Conventionally, the disc filter generally includes a filter element which is normally a filter diaphragm fixed (e.g. by welding) between two housing parts of a filter housing. Usually, the filter element is supported across its whole surface by filter support means, which are formed inside the housing parts as a part of the housing. In some cases, these filters may provide inadequate flow uniformity, too high flow resistance, and inadequate burst strength across a broad range of fluids of differing flowrates and characteristics. Therefore, improvements in filters are needed, particularly in enabling filters to achieve optimal flow uniformity, flow resistance, and burst strength.

### BRIEF DESCRIPTION OF THE DRAWINGS

Embodiments are illustrated by way of example and are not limited in the accompanying figures.

FIG. 1 illustrates a front side view of a prior art filter.

FIG. 2A illustrates a front side view of a filter according to a number of embodiments of the present disclosure.

FIG. 2B illustrates a perspective cross-sectional view of a filter according to a number of embodiments of the present disclosure.

FIG. 2C illustrates a cross-sectional view of a filter according to a number of embodiments of the present disclosure.

FIG. 2D1 illustrates a perspective top view of a first housing member of a filter according to a number of embodiments of the present disclosure.

FIG. 2D2 illustrates a perspective top view of a first housing member of a filter according to a number of embodiments of the present disclosure.

FIG. 2D3 illustrates a perspective top view of a first housing member of a filter according to a number of embodiments of the present disclosure.

FIG. 2E illustrates a perspective top view of a first housing member of a filter according to a number of embodiments of the present disclosure.

FIG. 2F illustrates a perspective top view of a second housing member of a filter according to a number of embodiments of the present disclosure.

FIG. 3 illustrates a point graph of pressure (bar) applied on a filter versus maximum principal strain (mm/mm) of a conventional filter (A) versus a filter (B) according to embodiments herein.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings. However, other embodiments can be used based on the teachings as disclosed in this application.

The terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one, at least one, or the singular as also including the plural, or vice versa, unless it is clear that it is meant otherwise. For example, when a single embodiment is described herein, more than one embodiment may be used in place of a single embodiment. Similarly, where more than one embodiment is described herein, a single embodiment may be substituted for that more than one embodiment.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the filter arts.

The following disclosure describes filters adapted to provide better efficiency of fluid filtration and movement through a filter connecting neighboring pieces of a conduit. The concepts are better understood in view of the embodiments described below that illustrate and do not limit the scope of the present invention.

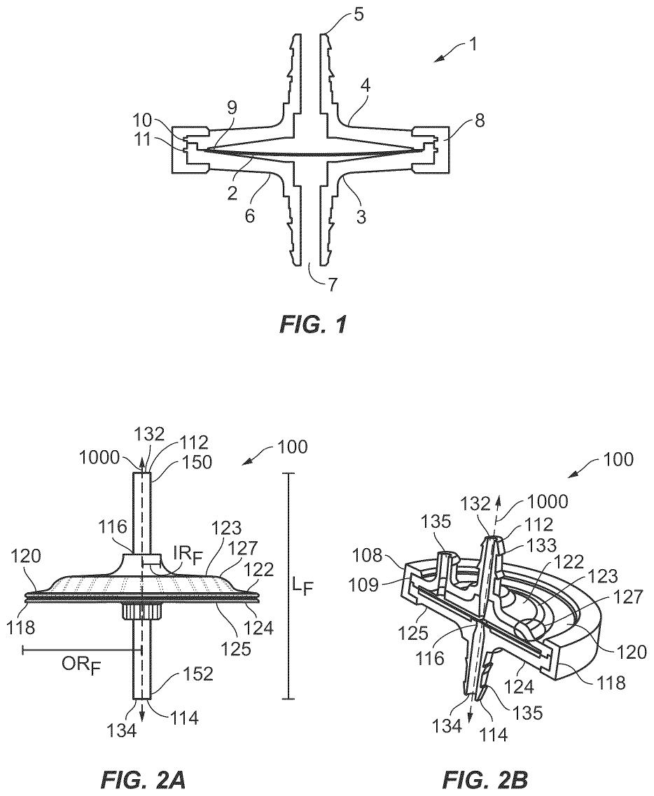

FIG. 1 illustrates a front side view of a prior art filter 1. This filter 1 includes a filter element or membrane 2 disposed internally of a housing 3 with inlet and outlet openings 5 and 7 on two parts 4 and 6, respectively. These parts may be assembled and fused or bonded into an integral filter 1 by means of an injection molded sealing member 8 of thermoplastic material. Scaling member 8 completely surrounds and fills a joint 9 and thereby forms an integral part of the filter 1. In the represented embodiment, at least one of the housing parts has a shortened exterior lip 10, 11 such that at least a part of the lateral surface of filter element 2 will be directly exposed to the thermoplastic sealing member 8.

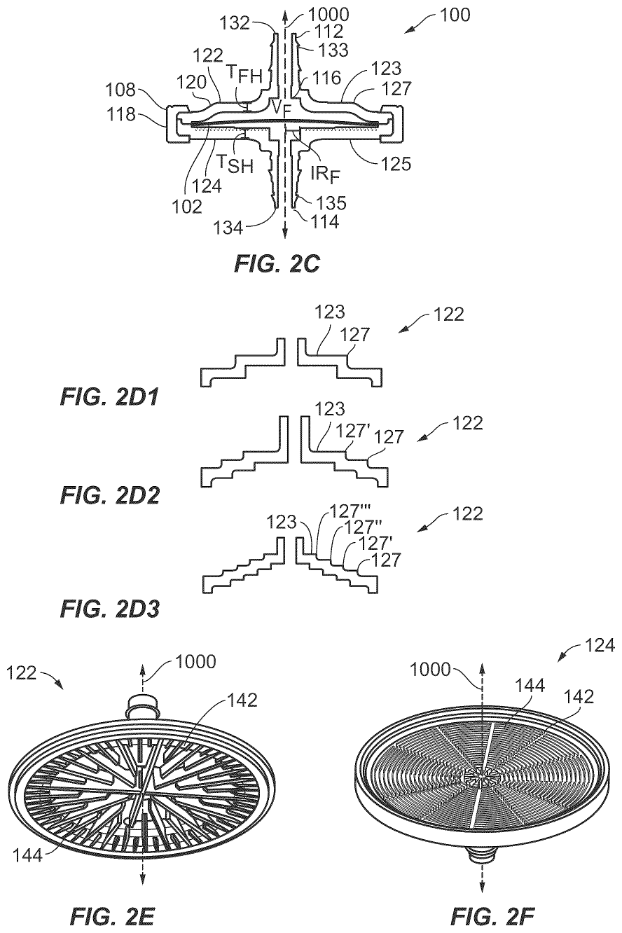

For purposes of illustration, FIG. 2A illustrates a front side view of a filter according to a number of embodiments of the present disclosure. For purposes of illustration, FIG. 2B illustrates a perspective cross-sectional view of a filter according to a number of embodiments of the present disclosure. For purposes of illustration, FIG. 2C illustrates a cross-sectional view of a filter according to a number of embodiments of the present disclosure. As shown in FIGS. 2A-2C, in a number of embodiments, the filter 100 may include a first axial end 112, a second axial end 114, an inner radius edge 116 and an outer radius edge 118 oriented down a central axis 1000. In a number of embodiments, the filter 100 may include a housing 120. The housing 120 may include a first housing member 122 and a second housing member 124. In a number of embodiments, the first housing member 122 may have generally flat cross-section in a plane perpendicular to the central axis. In a number of embodiments, the first housing member 122 may be generally polygonal cross-section (e.g. rectangular). In a number of variations, the first housing member 122 may have a polygonal, oval, circular, semi-circular, or substantially circular cross-section. In a number of embodiments, the second housing member 124 may have generally flat cross-section in a plane perpendicular to the central axis. In a number of embodiments, the second housing member 124 may be generally polygonal cross-section (e.g. rectangular). In a number of variations, the second housing member 124 may have a polygonal, oval, circular, semi-circular, or substantially circular cross-section. In certain embodiments, as shown best in FIG. 2A, the first housing member 122 may include a general frustoconical cross- sectional profile. In certain embodiments, as shown best in FIG. 2A, the second housing member 124 may include a general circular cross-sectional profile. Further, in certain embodiments, as shown, the second housing member 124 may include a substantially rectilinear radial sidewall 125. Further, in certain embodiments, as shown, the substantially rectilinear radial sidewall 125 of the second housing member 124 may be substantially perpendicular to the central axis 1000 of the filter 100.

In a number of embodiments, as shown best in FIG. 2A, the filter 100 may have an outer radius OR_{F}. For purposes of embodiments described herein and as shown best in FIG. 2A, the filter 100 may have an outer radius OR_{F} is the distance from the central axis 1000 to the outer radius edge 118. According to certain embodiment, filter 100 may have an outer radius OR_{F} that may be at least at least 5 mm, about 10 mm, at least 25 mm, at least 50 mm, at least 100 mm, at least about 150 mm or at least about 200 mm or at least about 250 mm or at least about 300 mm or even at least about 500 mm. According to still other embodiments, filter 100 may have an outer radius OR_{F} that may be not greater than about 1500 mm, not greater than about 1200 mm or even not greater than about 1000 mm. It will be appreciated that the filter 100 may have an outer radius OR_{F} that may be within a range between any of the minimum and maximum values noted above. It will be further appreciated that the filter 100 may have an outer radius OR_{F} that may be any value between any of the minimum and maximum values noted above.

In a number of embodiments, as shown best in FIGS. 2A-2C, the filter 100 may have an inner radius IR_{F}. For purposes of embodiments described herein and as shown best in FIG. 2B-2C, the filter 100 may have an inner radius IR_{F} is the distance from the central axis 1000 to the inner radius edge 116. According to certain embodiment, filter 100 may have an inner radius IR_{F} that may be at least 1 mm, at least 2 mm, at least 5 mm, at least about 10 mm, at least 25 mm, at least 50 mm, at least 100 mm, at least about 150 mm or at least about 200 mm or at least about 250 mm or at least about 300 mm or even at least about 500 mm. According to still other embodiments, filter 100 may have an inner radius IR_{F} that may be not greater than about 1500 mm, not greater than about 1200 mm or even not greater than about 1000 mm. It will be appreciated that the filter 100 may have an inner radius IR_{F} that may be within a range between any of the minimum and maximum values noted above. It will be further appreciated that the filter 100 may have an inner radius IR_{F} that may be any value between any of the minimum and maximum values noted above.

In a number of embodiments, the filter 100 can have an axial length L_{F}. For purposes of embodiments described herein and as shown in FIG. 2A, the length L_{F} of the filter 100 is the distance from the first axial end 112 to the second axial end 114. According to certain embodiment, the length L_{F} of the filter 100 may be at least about 10 mm, at least 25 mm, at least 50 mm, at least 100 mm, at least about 150 mm or at least about 200 mm or at least about 250 mm or at least about 300 mm, or even at least about 500 mm. According to still other embodiments, the length L_{F} of the filter 100 may be not greater than about 1500 mm, not greater than about 1200 mm or even not greater than about 1000 mm. It will be appreciated that the length L_{F} of the filter 100 may be within a range between any of the minimum and maximum values noted above. It will be further appreciated that the length L_{F} of the filter 100 may be any value between any of the minimum and maximum values noted above.

In a number of embodiments, the first housing member 122 may have a thickness T_{FH}. For purposes of embodiments described herein and as shown in FIG. 2C, the thickness T_{FH} of the first housing member 122 may be at least about 0.001 mm, such as, at least about 0.005, at least about 0.01 mm, at least about 0.05 mm, at least about 0.1 mm, or at least about 0.2 mm or at least about 0.3 mm or at least about 0.4 mm or even at least about 0.5 mm. According to still other embodiments, the thickness T_{FH} of the first housing member 122 may be not greater than about 10 mm, such as, not greater than 5 mm, not greater than 1 mm, not greater than about 0.5 mm or even not greater than about 0.25 mm. It will be appreciated that the thickness T_{FH} of the first housing member 122 may be within a range between any of the minimum and maximum values noted above. It will be further appreciated that the thickness T_{FH} of the first housing member 122 may be any value between any of the minimum and maximum values noted above. In a number of embodiments, the thickness T_{FH} of the first housing member 122 may be between 1 μm and 1000 μm, such as between 5 μm and 500 μm, or such as between 20 μm and 350 μm.

In a number of embodiments, the second housing member 124 may have a thickness T_{SH}. For purposes of embodiments described herein and as shown in FIG. 2C, the thickness T_{SH} of the second housing member 124 may be at least about 0.001 mm, such as, at least about 0.005, at least about 0.01 mm, at least about 0.05 mm, at least about 0.1 mm, or at least about 0.2 mm or at least about 0.3 mm or at least about 0.4 mm or even at least about 0.5 mm. According to still other embodiments, the thickness T_{SH} of the second housing member 124 may be not greater than about 10 mm, such as, not greater than 5 mm, not greater than 1 mm, not greater than about 0.5 mm or even not greater than about 0.25 mm. It will be appreciated that the thickness T_{SH} of the second housing member 124 may be within a range between any of the minimum and maximum values noted above. It will be further appreciated that the thickness T_{SH} of the second housing member 124 may be any value between any of the minimum and maximum values noted above. In a number of embodiments, the thickness T_{SH} of the second housing member 124 may be between 1 μm and 1000 μm, such as between 5 μm and 500 μm, or such as between 20 μm and 350 μm.

In a number of embodiments, as shown in FIG. 2C, the filter 100 can have an internal volume V_{F}. For purposes of embodiments described herein, the volume, V_{F}, of the filter 100 may be at least about 0.1 mL, 1 mL, 10 mL, 50 mL, 100 mL, 250 mL, 500 mL, 0.1 L, such as, at least about 0.5 L or at least about 1 L or at least about 2 L or at least about 5 L, or even at least about 10 L. According to still other embodiments, the volume, V_{F}, of the filter 100 may be not greater than about 150 L, such as, not greater than about 100 L, not greater than about 50 L or even not greater than about 25 L. It will be appreciated that the first volume, V_{F}, of the filter 100 may be within a range between any of the minimum and maximum values noted above. It will be further appreciated that the first volume, V_{F}, of the filter 100 may be any value between any of the minimum and maximum values noted above.

As shown in FIG. 2A-2C, the first housing member 122 may include a radial sidewall 123 including at least one axial step 127. In a number of embodiments, the at least one axial step 127 may be generally polygonal cross-section (e.g. rectangular). In a number of variations, the at least one axial step 127 may have a polygonal, oval, circular, semi-circular, or substantially circular cross-section. In a number of embodiments, the at least one axial step 127 may have generally flat cross-section in a plane perpendicular to the central axis. In a number of embodiments, the first housing member 122 may include a radial sidewall 123 including a plurality of axial steps 127. For purposes of illustration, FIG. 2D1 illustrates a cross-sectional view of a first housing member of a filter according to a number of embodiments of the present disclosure. For purposes of illustration, FIG. 2D2 illustrates a cross-sectional view of a first housing member of a filter according to a number of embodiments of the present disclosure. For purposes of illustration, FIG. 2D3 illustrates a cross-sectional view of a first housing member of a filter according to a number of embodiments of the present disclosure. As shown in FIGS. 2D1-2D3, the axial steps 127 may extend upwards along the radial sidewall 123 of the first housing member. Further, as shown in FIGS. 2D1-2D3, the at least one axial step 127 may include at least 2, at least 3, at least 4, at least 5, at least 6, at least 7, at least 8, at least 9, at least 10 axial steps. Further, as shown in FIGS. 2D1-2D3, the at least one axial step 127 may be rectilinear or arcuate.

Referring back to FIG. 2B, in a number of embodiments, at least one of the first housing member 122 or the second housing member 124 may include at least one vent 135. In a number of embodiments, the at least one vent 135 may vent air from the filter 100 into the surrounding environment outside the housing 120. The at least one vent 135 may be monolithic with at least one of the first housing member 122 or the second housing member 124.

Referring now to FIGS. 2A-2C, in a number of embodiments, the first housing member 122 may have a fluid inlet port 132 at a first axial end 112 of the filter. In a number of embodiments, the second housing member 124 may have a fluid outlet port 134 at a second axial end 114 of the filter 100. In a number of embodiments, at least one of the fluid inlet port 132 or fluid outlet port 134 may include a bore, spigot, nozzle, or any known variation for feeding fluid into the filter 100 as known conventionally in the art. As shown best in FIG. 2A, the fluid inlet port 132 or the fluid outlet port 134 may connect to a conduit adapted to house and move fluid into and out of the filter 100. In a number of embodiments, as shown best in FIG. 2C, the fluid inlet port 132 may include a fluid conduit attachment feature 133 including a surface structure modification. The surface structure modification can be a barb, lip, stay, ramp, tab, textured/grippable surface, clip, nut, bolt, bearing, batten, buckle, flange, frog, grommet, hook-and-eye, latch, peg, nail, rivet, tongue-and groove, screw anchor, snap fastener, stitch, threaded fastener, tie, toggle bolt, wedge anchor, screw, clamp, clasp, pin, or combination thereof. In a number of embodiments, the fluid conduit attachment feature 133 may attach the filter to the conduit. In a number of embodiments, the fluid outlet port 134 may include a fluid conduit attachment feature 135 including a surface structure modification. The surface structure modification can be a barb, lip, stay, ramp, tab, textured/grippable surface, clip, nut, bolt, bearing, batten, buckle, flange, frog, grommet, hook-and-eye, latch, peg, nail, rivet, tongue-and groove, screw anchor, snap fastener, stitch, threaded fastener, tie, toggle bolt, wedge anchor, screw, clamp, clasp, pin, or combination thereof. In a number of embodiments, the fluid conduit attachment feature 135 may attach the filter to the conduit.

As shown best in FIGS. 2B-2C, in a number of embodiments, the first and second housing 122, 124 may be fused or bonded into an integral filter 100 by means of a thermoplastic overmold 108. In a number of embodiments, the thermoplastic overmold 108 may be molded over the periphery of the housing members 122, 124 sealing the periphery of the housing members together to form an internal volume, V_{F}, housing the porous filter element 102. In a number of embodiments, the thermoplastic overmold 108 may contact the first housing member 122 or the second housing member 124 along at least 1% of its surface area, such as at least 5%, at least 10%, at least 20%, at least 25%, at least 50%, at least 60%, at least 75%, at least 80%, at least 90%, at least 95%, or at least 99%. In a number of embodiments, thermoplastic overmold 108 may completely surround and fill a joint 109 and thereby forms an integral housing 120. In a number of embodiments, the overmold 108 axially covers an axially outer surface of the sidewall 123, 125 of each of the first housing member 122 and the second housing member 124. In a number of embodiments, the overmold 108 molds the first housing member 122 to the second housing member 124 along the entirety of the periphery of the filter 100.

Still referring to FIGS. 2A-2C, in a number of embodiments, the two housing members may enclose a porous filter element or membrane 102 that may be disposed between the first and second housing members 122, 124. For example, in intravenous applications, the porous filter element or membrane 102 may be constructed from nylon, cellulose esters, or other equivalent stable and inert materials. In a number of embodiments, the porous filter element 102 may have an average pore size of between 0.005 μm and 1200 μm, such as between 0.50 μm and 1000 μm, such as between 1 μm and 500 μm, or such as between 1.5 μm and 250 μm. The pore size may range from 0.1 to 15 μm. A wide variety of such filter elements are available, and these are well known to those skilled in the art. In a number of embodiments, the porous filter element 102 may be molded to at least one of the first or second housing members 122, 124, or the overmold 108. In a number of embodiments, the porous filter element 102 may contact the first housing member 122 or the second housing member 124 along at least 1% of its surface area, such as at least 5%, at least 10%, at least 20%, at least 25%, at least 50%, at least 60%, at least 75%, at least 80%, at least 90%, at least 95%, or at least 99%.

For purposes of illustration, FIG. 2E illustrates a perspective top view of a first housing member of a filter according to a number of embodiments of the present disclosure. For purposes of illustration, FIG. 2F illustrates a perspective top view of a second housing member of a filter according to a number of embodiments of the present disclosure. Referring to FIGS. 2E-2F, in a number of embodiments, at least one of the first housing member 122 or the second housing member 124 may include at least one radial rib 142. In a number of embodiments, the at least one radial rib 142 may protrude interior to the first housing member 122 or the second housing member 124 to form a part of the internal volume of the filter 100. In a number of embodiments, the at least one radial rib 142 may aid in supporting the membrane 102 within the internal volume of the filter 100. As shown, the at least one radial rib 142 can be continuous or discrete. In a number of embodiments, at least one of the first housing member 122 or the second housing member 124 may include a plurality of radial ribs 142. In a number of embodiments, the first housing member 122 or the second housing member 124 have radial ribs 142 along at least 1% of its surface area, such as at least 5%, at least 10%, at least 20%, at least 25%, at least 50%, at least 60%, at least 75%, at least 80%, at least 90%, at least 95%, or at least 99%. In a number of embodiments, at least one of the first housing member 122 or the second housing member 124 may include at least one circumferential rib 144. In a number of embodiments, the at least one circumferential rib 144 may protrude interior to the first housing member 122 or the second housing member 124 to form a part of the internal volume of the filter 100. In a number of embodiments, the at least one circumferential rib 144 may aid in supporting the membrane 102 within the internal volume of the filter 100. As shown, the at least one circumferential rib 144 can be continuous or discrete. In a number of embodiments, at least one of the first housing member 122 or the second housing member 124 may include a plurality of circumferential ribs 144. In a number of embodiments, the first housing member 122 or the second housing member 124 have circumferential ribs 144 along at least 1% of its surface area, such as at least 5%, at least 10%, at least 20%, at least 25%, at least 50%, at least 60%, at least 75%, at least 80%, at least 90%, at least 95%, or at least 99%.

The filter 100 or any components thereof listed herein can be formed from any suitable material in the sealing arts. In a particular embodiment, the filter 100 or any components thereof listed herein can at least partially include a polymer. The polymer may be a thermoplastic or thermosetting polymer. The polymer may be selected from the group including a polyketone, a polyaramid, a polyphenylene sulfide, a polyethersulfone, a polypheylene sulfone, a polyamideimide, ultra high molecular weight polyethylene, a fluoropolymer, a polybenzimidazole, a polyacetal, polybutylene terephthalate (PBT), polypropylene (PP), rubber modified polypropylene, (EPDM/PP), polycarbonate (PC), Acrylonitrile butadiene styrene (ABS), polyethylene terephthalate (PET), a polyimide (PI), polyetherimide, polyetheretherketone (PEEK), polyatheretherketone (PAEK), polyethylene (PE), high density polyethylene (HDPE), a polysulfone, a polyamide (PA), thermoplastic polyurethane (TPU), polyphenylene oxide, polyphenylene sulfide (PPS), a polyurethane, a polyester, a liquid crystal polymer (LCP), an elastomer, or any combination thereof. In an embodiment, the filter 100 or any components thereof listed herein may include, or even consist essentially of, a fluoropolymer. Exemplary fluoropolymers include a polytetrafluoroethylene (PTFE), a modified PTFE (TFM), a fluorinated ethylene propylene (FEP), a polyvinylidene fluoride (PVDF), a perfluoroalkoxy (PFA), a terpolymer of tetrafluoroethylene, a hexafluoropropylene and vinylidene fluoride (THV), a polychlorotrifluoroethylene (PCTFE), an ethylene tetrafluoroethylene copolymer (ETFE), an ethylene chlorotrifluoroethylene copolymer (ECTFE), or any combination thereof. Other fluoropolymers, polymers, and blends may be included in the composition of the filter 100 or any components thereof listed herein. In another particular embodiment, the filter 100 or any components thereof listed herein can at least partially include, or even consist essentially of, a polyethylene (PE) such as an ultra-high-molecular-weight polyethylene (UHMWPE). In another particular embodiment, the filter 100 or any components thereof listed herein may include a thermoplastic elastomeric hydrocarbon block copolymer, a polyether-ester block co-polymer, a thermoplastic polyamide elastomer, a thermoplastic polyurethane elastomer, a thermoplastic polyolefin elastomer, a thermoplastic vulcanizate, an olefin-based co-polymer, an olefin-based ter-polymer, a polyolefin plastomer, or combinations thereof. In an embodiment, the filter 100 or any components thereof listed herein may include a styrene based block copolymer such as styrene-butadiene, styrene-isoprene, blends or mixtures thereof, and the like. Exemplary styrenic thermoplastic elastomers include triblock styrenic block copolymers (SBC) such as styrene-butadiene-styrene (SBS), styrene-isoprene-styrene (SIS), styrene-ethylene butylene-styrene (SEBS), styrene-ethylene propylene-styrene (SEPS), styrene-ethylene-ethylene-butadiene-styrene (SEEBS), styrene-ethylene-ethylene-propylene-styrene (SEEPS), styrene-isoprene-butadiene-styrene (SIBS), or combinations thereof. Commercial examples include some grades of Kraton™ and Hybrar™ resins. In an embodiment, the filter 100 or any components thereof listed herein may include an elastomer including at least one of Acrylonitrile-Butadiene (NBR) Carboxylated Nitrile (XNBR) Ethylene Acrylate (AEM, Vamac®), Ethylene Propylene Rubber (EPR, EPDM), Butyl Rubber (IIR), Chloroprene Rubber (CR), Fluorocarbon (FKM, FPM), Fluorosilicone (FVMQ), Hydrogenated Nitrile (HNBR), Perfluoroelastomer (FFKM), Polyacrylate (ACM), Polyurethane (AU, EU), Silicone Rubber (Q, MQ, VMQ, PVMQ), Tetrafluoroethylene-Propylene (AFLAS®) (FEPM). In a number of embodiments, the filter 100 or any components thereof listed herein may be formed from any conventional methods known for polymer manufacturing, such as injection molding, billeting, cutting/slicing, hot or cold pressing, direct forming, extrusion, skiving, machining, or CNC machining.

In an embodiment, the filter 100 or any components thereof listed herein can at least partially include a rigid material such as, but not limited to, a metal. According to certain embodiments, the metal may include iron, copper, titanium, tin, aluminum, alloys thereof, or may be another type of metal. In an embodiment, the filter 100 or any components thereof listed herein can include a metal (such as aluminum, zinc, copper, magnesium, tin, platinum, titanium, tungsten, iron, bronze, steel, energizer steel, stainless steel), a metal alloy (including the metals listed), an anodized metal (including the metals listed), or any combination thereof.

In an embodiment, the filter 100 or any components thereof listed herein can be treated, impregnated, filled, or coated with a lubricious material or filler. Exemplary lubricious materials or fillers include molybdenum disulfide, tungsten disulfide, graphite, grapheme, expanded graphite, boron nitrade, talc, calcium fluoride, or any combination thereof. Additionally, the lubricious material or filler can include a ceramic such as alumina, silica, titanium dioxide, calcium fluoride, boron nitride, mica, wollastonite, glass fibers, silicon carbide, silicon nitride, zirconia, carbon black, pigments, or any combination thereof. In an embodiment, the filter 100 or any components thereof listed herein may be a material that is resistant to oxygen, hydrogen, hydroxide, or temperature resistant. In a number of embodiments, the filter 100 or any components thereof listed herein may be monolithic. In alternative embodiments, the filter 100 or any components thereof listed herein may not be monolithic and may include multiple pieces.

In an embodiment, the filter 100 or any components thereof listed herein can advantageously withstand sterilization processes. In an embodiment, the filter 100 or any components thereof listed herein may be sterilized by any method envisioned. For instance, the polymer of the filter 100 is sterilized after the filter 100 is formed. Exemplary sterilization methods include radiation (such as X-ray radiation), electron ray, E-beam or electron beam sterilization techniques, combinations thereof, and the like. In a particular embodiment, the polymer or polymeric blend is sterilized by vaporized hydrogen peroxide sterilization (VHP). In a particular embodiment, the filter 100 or any components thereof listed herein is sterilized by gamma irradiation. For instance, the filter 100 or any components thereof listed herein may be gamma sterilized at between about 25 kGy to about 50 kGy.

In embodiment, the filter 100 or any components thereof listed herein may have further desirable physical and mechanical properties. For instance, the filter 100 or any components thereof listed herein may appear transparent or at least translucent. For instance, the filter 100 or any components thereof listed herein may have a light transmission greater than about 2%, or greater than about 5% in the visible light wavelength range. In particular, the resulting articles have desirable clarity or translucency. In addition, the filter 100 or any components thereof listed herein may have advantageous physical properties, such as a balance of any one or more of the properties of hardness, flexibility, surface lubricity, tensile strength, elongation, Shore A hardness, gamma resistance, weld strength, and seal integrity to an optimum level.

In an embodiment, the filter 100 or any components thereof listed herein may have desirable heat stability properties. Applications for the polymer or polymeric blend are numerous. In particular, the filter 100 or any components thereof listed herein may be non-toxic, making the material useful for any application where no toxicity is desired. For example, the filter 100 or any components thereof listed herein may be substantially free of plasticizers or other low-molecular weight extenders that can be leached into the fluids it transfers. “Substantially free” as used herein refers to a polymeric mixture having a total organic content (TOC) (measured in accordance to ISO 15705 and EPA 410.4) of less than about 100 ppm. Further, the filter 100 or any components thereof listed herein has biocompatibility and animal derived component-free formulation ingredients. For instance, the filter 100 or any components thereof listed herein may have potential for FDA, USP, EP, ISO, and other regulatory approvals. In an exemplary embodiment, the filter 100 or any components thereof listed herein may be used in applications such as industrial, medical, health care, biopharmaceutical, pharmaceutical, drinking water, food & beverage, laboratory, dairy, and the like. In an embodiment, the filter 100 or any components thereof listed herein may be used in applications where low temperature resistance is desired. In an embodiment, the filter 100 or any components thereof listed herein may also be safely disposed as it generates substantially no toxic gases when incinerated and leaches no plasticizers into the environment if land filled.

In some embodiments, the filter 100 may be configured to contain and filter a product. The product may be medical, biological, or pharmaceutical fluid. In a number of embodiments, the product may include a biomedia fluid for use in medical, biological, or pharmaceutical applications. In a number of embodiments, the product may include a biological agent. In a number of embodiments, the product may include a fluid for use in medical, biological, or pharmaceutical applications.

A method may be used for forming a filter according to a number of embodiments. The method may include a first step including providing a fluid inlet conduit. The method may include a second step of providing a fluid outlet conduit. The method may include a third step of providing a filter coupling the fluid inlet conduit to the fluid outlet conduit, where the filter includes: a first housing member having a fluid inlet port; and a second housing member positioned axially underneath the first housing member, the second housing member having a fluid outlet port; a porous filter element sandwiched between the first and second housing members; and a thermoplastic overmold which may be molded over the periphery of the housing members sealing the periphery of the housing members together to form an internal volume housing the porous filter element, where the first housing member includes a radial sidewall including at least one axial step, and where the second housing member includes a substantially rectilinear radial sidewall. The method may include a fourth step of flowing a fluid through the fluid inlet conduit into the filter and into the fluid outlet conduit.

Use of the filter may provide increased benefits in several applications in fields such as, but not limited to, industrial, medical, health care, biopharmaceutical, pharmaceutical, drinking water, food & beverage, laboratory, dairy, or other types of applications. Notably, the use of filters according to embodiments herein may provide improved flow uniformity, lower flow resistance, and more adequate burst strength across a broad range of fluids of differing flowrates and characteristics over existing filters, increasing filter lifespan and performance efficiency.

### EXAMPLES

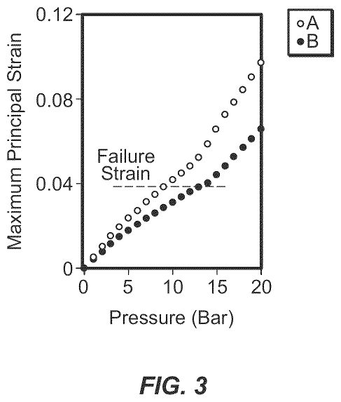

In a number of embodiments, filters according to embodiments herein may show improved burst strength versus existing filters. FIG. 3 illustrates a point graph of pressure (bar) applied on a filter versus maximum principal strain (mm/mm) of a conventional filter (A) versus a filter (B) according to embodiments herein.

As shown in FIG. 3, filters according to embodiments herein have a higher burst strength (i.e. maximum principal strain) as pressure increases versus existing filters. In a number of embodiments, filters according to embodiments herein may have a relative burst strength of at least 40 Pa/mm² (strength per unit filtration area), through the filter.

In a number of embodiments, filters according to embodiments herein may show improved velocity resistance versus existing filters. Table 1 shows a standard deviation of velocity over cross-section used to evaluate flow uniformity and flow resistance of a filter according to embodiments herein versus a conventional filter.

TABLE 1

| Housing Design | Standard Deviation (cm/s) |
|---|---|
| Prior Art 1 | 6.31E−02 |
| Prior Art 2 | 4.20E−03 |
| Filter 3 | 2.54E−02 |

As shown in Table 1, filters according to embodiments herein have a better flow uniformity and velocity resistance versus existing filters. In a number of embodiments, filters according to embodiments herein may define a pressure drop of no greater than 29,000 Pa at a fluid flowrate of 2.94 ml/(min.cm²) through the filter, when the water is used as fluid, and the transmembrane flow of porous filter element (which is defined as the flowrate per pressure drop per surface area) is 4 ml/(min·cm²·bar), and the inner diameter of porous filter element is 57 mm measured by inner diameter of disc filter. It is contemplated that other sizes of the porous filter element would perform similarly. Pressure drop of filter can be measured by pressure difference between the pressure gauges closely installed upstream and downstream of filter, flowrate can be measured by flow meter along the system. In a number of embodiments, filters according to embodiments herein may define a standard deviation of velocity across a surface of porous filter element upstream of no greater than 0.04 cm/s at a fluid flowrate of 2.94 ml/(min.cm²) through the filter, and in other embodiments no greater than 0.026 cm/s, when the water is used as fluid, and the transmembrane flow of porous filter element (which is defined as the flowrate per pressure drop per surface area) is 4 ml/(min·cm²·bar), and the diameter of porous filter element is 57 mm. The standard deviation (σ) is defined as the below equation (uᵢ is the local velocity, u is average velocity across the surface, n is the number of meshes (i.e. crossed filaments mesh size is 0.2 mm, for 57 mm diameter filter, number of mesh in cross section is about 63800) in the cross-sectional area defined for testing):

$$σ = \sqrt{\frac{{\sum }_{i = 1}^{n} {( {u}_{i} - u )}^{2}}{n}}$$

This value can be obtained by using the commercial CFD software ANSYS-Fluent. In detail, to input the given filter housing geometry, membrane property, fluid property and given fluid flowrate, standard deviation can be obtained from post-processing of CFD results.

Many different aspects and embodiments are possible. Some of those aspects and embodiments are described below. After reading this specification, skilled artisans will appreciate that those aspects and embodiments are only illustrative and do not limit the scope of the present invention.

Embodiment 1. A filter comprising: a first housing member having a fluid inlet port; and a second housing member positioned axially underneath the first housing member, the second housing member having a fluid outlet port; a porous filter element disposed between the first and second housing members; and a thermoplastic overmold which is molded over the periphery of the housing members sealing the periphery of the housing members together to form an internal volume housing the porous filter element, wherein the first housing member comprises a radial sidewall comprising at least one axial step, and wherein the second housing member comprises a substantially rectilinear radial sidewall.

Embodiment 2. A filter comprising: a first housing member having a fluid inlet port; and a second housing member positioned axially underneath the first housing member, the second housing member having a fluid outlet port; a porous filter element disposed between the first and second housing members; and a thermoplastic overmold which is molded over the periphery of the housing members sealing the periphery of the housing members together to form an internal volume housing the porous filter element, wherein at least one of 1) the first housing member comprises a radial sidewall comprising at least one axial step providing a relative burst strength of at least 40Pa/mm\hat{ }2 (strength per unit filtration area), or 2) the second housing member comprises a substantially rectilinear radial sidewall defining a pressure drop of no greater than 29,000 Pa at a fluid flowrate of 75 ml/min through the filter.

Embodiment 3. An assembly comprising: a fluid inlet conduit; a fluid outlet conduit; and a filter coupling the fluid inlet conduit to the fluid outlet conduit, wherein the filter comprises: a first housing member having a fluid inlet port; and a second housing member positioned axially underneath the first housing member, the second housing member having a fluid outlet port; a porous filter element disposed between the first and second housing members; and a thermoplastic overmold which is molded over the periphery of the housing members sealing the periphery of the housing members together to form an internal volume housing the porous filter element, wherein the first housing member comprises a radial sidewall comprising at least one axial step, and wherein the second housing member comprises a substantially rectilinear radial sidewall.

Embodiment 4. A method comprising: providing a fluid inlet conduit; providing a fluid outlet conduit; providing a filter coupling the fluid inlet conduit to the fluid outlet conduit, wherein the filter comprises: a first housing member having a fluid inlet port; and a second housing member positioned axially underneath the first housing member, the second housing member having a fluid outlet port; a porous filter element disposed between the first and second housing members; and a thermoplastic overmold which is molded over the periphery of the housing members sealing the periphery of the housing members together to form an internal volume housing the porous filter element, wherein the first housing member comprises a radial sidewall comprising at least one axial step, and wherein the second housing member comprises a substantially rectilinear radial sidewall; and flowing a fluid through the fluid inlet conduit into the filter and into the fluid outlet conduit.

Embodiment 5. The filter, assembly, or method according to any one of the preceding embodiments, wherein at least one of the first housing member or the second housing member comprises a thermoplastic material.

Embodiment 6. The filter, assembly, or method according to any one of the preceding embodiments, wherein at least one of the first housing member or the second housing member comprises at least one circumferential rib.

Embodiment 7. The filter, assembly, or method according to any one of the preceding embodiments, wherein at least one of the first housing member or the second housing member comprises at least one radial rib.

Embodiment 8. The filter, assembly, or method according to any one of the preceding embodiments, wherein the first housing member has a generally frustoconical cross-sectional profile.

Embodiment 9. The filter, assembly, or method according to any one of the preceding embodiments, wherein the second housing member has a circular cross-sectional profile.

Embodiment 10. The filter, assembly, or method according to any one of the preceding embodiments, wherein the second housing member wherein the substantially rectilinear radial sidewall is perpendicular to a central axis of the filter.

Embodiment 11. The filter, assembly, or method according to any one of the preceding embodiments, wherein the filter defines a relative burst strength of at least 40 Pa/mm² (strength per unit filtration area), through the filter.

Embodiment 12. The filter, assembly, or method according to any one of the preceding embodiments, wherein the filter defines a pressure drop of no greater than 29,000 Pa at a fluid flowrate of 75 ml/min through the filter.

Embodiment 13. The filter, assembly, or method according to any one of the preceding embodiments, wherein the first housing member further defines a vent.

Embodiment 14. The filter, assembly, or method according to any one of the preceding embodiments, wherein the overmold molds the first housing member to the second housing member along the entirety of the periphery of the filter.

Embodiment 15. The filter, assembly, or method according to any one of the preceding embodiments, wherein the overmold axially covers an axially outer surface of the sidewall of each of the first housing member and the second housing member.

Embodiment 16. The filter, assembly, or method according to any one of the preceding embodiments, wherein the fluid inlet port comprises a fluid conduit attachment feature comprising a surface structure modification.

Embodiment 17. The filter, assembly, or method according to embodiment 16, wherein the surface structure modification comprises at least one barb.

Embodiment 18. The filter, assembly, or method according to any one of the preceding embodiments, wherein the fluid outlet port comprises a fluid conduit attachment feature comprising a surface structure modification.

Embodiment 19. The filter, assembly, or method according to embodiment 18, wherein the surface structure modification comprises at least one barb.

Embodiment 20. The filter, assembly, or method according to any one of the preceding embodiments, wherein the radial sidewall of the first housing member comprises a plurality of axial steps.

Embodiment 21. The filter, assembly, or method according to any one of the preceding embodiments, wherein at least one of the first housing member or the second housing member comprises a plurality of circumferential ribs.

Embodiment 22. The filter, assembly, or method according to any one of the preceding embodiments, wherein at least one of the first housing member or the second housing member comprises a plurality of radial ribs.

Embodiment 23. The filter, assembly, or method according to any one of the preceding embodiments, wherein the porous filter element comprises a thermoplastic.

Embodiment 24. The filter, assembly, or method according to any one of the preceding embodiments, wherein the porous filter element comprises a metal.

Embodiment 25. The filter, assembly, or method according to any one of the preceding embodiments, wherein a peripheral edge of the porous filter element is molded to at least one of the first housing member, the second housing member, or the overmold.

Embodiment 26. The filter, assembly, or method according to any one of the preceding embodiments, wherein at least one of the first housing member, the second housing member, or the overmold comprises a monolithic piece.

Embodiment 27. The filter, assembly, or method according to any one of the preceding embodiments, wherein the porous filter element has an average pore size between 5 nm and 1200 μm.

Embodiment 28. The filter, assembly, or method according to any one of the preceding embodiments, wherein the filter has an axial length of greater than 15 mm.

Embodiment 29. The filter, assembly, or method according to any one of the preceding embodiments, wherein the filter has an outer radius of greater than 25 mm.

Embodiment 30. The filter, assembly, or method according to any one of the preceding embodiments, wherein the filter is sterilizable.

Embodiment 31. The filter, assembly, or method according to any one of the preceding embodiments, wherein the filter defines a standard deviation of velocity across the surface of porous filter element upstream of no greater than 0.04 m/s at a fluid flowrate of 75 ml/min through the filter.

Embodiment 32. The filter, assembly, or method according to any one of the preceding embodiments, wherein the second housing member contacts the porous filter element along at least 1% of a surface area of the porous filter element.

Note that not all of the activities described above in the general description or the examples are required, that a portion of a specific activity may not be required, and that one or more further activities may be performed in addition to those described. Still further, the order in which activities are listed is not necessarily the order in which they are performed.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

Note that not all of the activities described above in the general description or the examples are required, that a portion of a specific activity may not be required, and that one or more further activities may be performed in addition to those described. Still further, the order in which activities are listed are not necessarily the order in which they are performed.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

After reading the specification, skilled artisans will appreciate that certain features are, for clarity, described herein in the context of separate embodiments, and may also be provided in combination in a single embodiment. Conversely, various features that are, for brevity, described in the context of a single embodiment, may also be provided separately or in any subcombination. Further, references to values stated in ranges include each and every value within that range.

What is claimed:

1. A filter comprising:
a first housing member having a fluid inlet port; and
a second housing member positioned axially underneath the first housing member, the second housing member having a fluid outlet port;
a porous filter element disposed between the first and second housing members; and
a thermoplastic overmold which is molded over the periphery of the housing members sealing the periphery of the housing members together to form an internal volume housing the porous filter element, wherein the first housing member comprises a radial sidewall comprising at least one axial step, and wherein the second housing member comprises a substantially rectilinear radial sidewall.

2. A filter comprising:
a first housing member having a fluid inlet port; and
a second housing member positioned axially underneath the first housing member, the second housing member having a fluid outlet port;
a porous filter element disposed between the first and second housing members; and
a thermoplastic overmold which is molded over the periphery of the housing members sealing the periphery of the housing members together to form an internal volume housing the porous filter element, wherein at least one of 1) the first housing member comprises a radial sidewall comprising at least one axial step providing a relative burst strength of at least 40Pa/mm\hat{ }2 (strength per unit filtration area), or 2) the second housing member comprises a substantially rectilinear radial sidewall defining a pressure drop of no greater than 29,000 Pa at a fluid flowrate of 75 ml/min through the filter.

3. An assembly comprising:
a fluid inlet conduit;
a fluid outlet conduit; and
a filter coupling the fluid inlet conduit to the fluid outlet conduit, wherein the filter comprises:
a first housing member having a fluid inlet port; and
a second housing member positioned axially underneath the first housing member, the second housing member having a fluid outlet port;
a porous filter element disposed between the first and second housing members; and
a thermoplastic overmold which is molded over the periphery of the housing members sealing the periphery of the housing members together to form an internal volume housing the porous filter element, wherein the first housing member comprises a radial sidewall comprising at least one axial step, and wherein the second housing member comprises a substantially rectilinear radial sidewall.

4. The filter of claim 1, wherein at least one of the first housing member or the second housing member comprises at least one circumferential rib.

5. The filter of claim 1, wherein at least one of the first housing member or the second housing member comprises at least one radial rib.

6. The filter of claim 1, wherein the first housing member has a generally frustoconical cross-sectional profile.

7. The filter of claim 1, wherein the second housing member has a circular cross-sectional profile.

8. The filter of claim 2, wherein the substantially rectilinear radial sidewall is perpendicular to a central axis of the filter.

9. The filter of claim 1, wherein the filter defines a relative burst strength of at least 40 Pa/mm² (strength per unit filtration area) through the filter.

10. The filter of claim 1, wherein the filter defines a pressure drop of no greater than 29,000 Pa at a fluid flowrate of 75 ml/min through the filter.

11. The filter of claim 1, wherein the overmold molds the first housing member to the second housing member along the entirety of the periphery of the filter.

12. The filter of claim 1, wherein the overmold axially covers an axially outer surface of the sidewall of each of the first housing member and the second housing member.

13. The filter of claim 1, wherein at least one of the fluid inlet port or the fluid outlet port comprises a fluid conduit attachment feature comprising a surface structure modification.

14. The filter of claim 13, wherein the surface structure modification comprises at least one barb.

15. The filter of claim 1, wherein the radial sidewall of the first housing member comprises a plurality of axial steps.

16. The filter of claim 1, wherein at least one of the first housing member or the second housing member comprises a plurality of circumferential ribs.

17. The filter of claim 1, wherein at least one of the first housing member or the second housing member comprises a plurality of radial ribs.

18. The filter of claim 1, wherein a peripheral edge of the porous filter element is molded to at least one of the first housing member, the second housing member, or the overmold.

19. The filter of claim 1, wherein the filter defines a standard deviation of velocity across the surface of the porous filter element upstream of no greater than 0.04 m/s at a fluid flowrate of 75 ml/min through the filter.

20. The filter of claim 1, wherein the second housing member contacts the porous filter element along at least 1% of a surface area of the porous filter element.
